(19) United States
(12) Patent Application Publication
(10) Pub. No.: US 2025/0259312 A1
(43) Pub. Date: Aug. 14, 2025

(54) SCENE FLOW ESTIMATION TECHNIQUES

(71) Applicant: QUALCOMM Incorporated, San Diego, CA (US)

(72) Inventors: Jun Wang, Novi, MI (US); Varun Ravi Kumar, San Diego, CA (US); Senthil Kumar Yogamani, Headford (IE)

(21) Appl. No.: 18/441,820

(22) Filed: Feb. 14, 2024

(51) Int. Cl. G06T 7/207; B60W 60/00; G06T 7/246; G06T 7/60; G06T 17/00

(52) U.S. Cl. CPC G06T 7/207; B60W 60/001; G06T 7/248; G06T 7/60; G06T 17/00; B60W 2420/403; B60W 2554/4044; G06T 2207/10028; G06T 2207/20081; G06T 2207/30261; G06T 2210/56

(57) ABSTRACT

An apparatus includes a processing system configured to receive a first point cloud representing a scene at a first time and to receive a second point cloud representing at least a portion of the scene at a second time after the first time. The processing system is further configured to determine one or more first neighbor points within the second point cloud that are within a first radius of a location and to determine one or more second neighbor points within the second point cloud that are within a second radius of the location. The processing system is further configured to determine a multi-resolution flow embedding for the first point based on the one or more first neighbor points and the one or more second neighbor points and to generate a scene flow model associated with the scene based on the multi-resolution flow embedding.

### TECHNICAL FIELD

Aspects of the present disclosure relate generally to scene flow estimation techniques for vehicles and other devices.

### INTRODUCTION

Vehicles take many shapes and sizes, are propelled by a variety of propulsion techniques, and may carry cargo including humans, animals, or objects. These machines have enabled the movement of cargo across long distances, movement of cargo at high speed, and movement of cargo that is larger than could be moved by human exertion. Vehicles may be manually operated by humans to arrive at a destination or may be autonomous, such as in the case of a drone or other autonomous vehicle. Various techniques have been developed to assist or autonomize vehicle operation. Such techniques may include adaptive cruise control, lane change assistance, collision avoidance, night vision, navigation, parking assistance, and blind spot detection.

To facilitate such features, a vehicle may use scene flow estimation. Scene flow estimation may involve sensing the surroundings of the vehicle, such as using a sensing system to capture frames associated with the surroundings. The frames may be used to create point clouds representing the surroundings. The point clouds may be processed and analyzed to detect objects and to perform other operations.

Some scene flow estimation techniques may perform relatively poorly in some circumstances. For example, some scene flow estimation techniques may inadequately distinguish the boundaries of objects in some circumstances. As another example, some scene flow estimation techniques may inadequately detect different types of objects, such as slower-moving objects (e.g., pedestrians) and faster-moving objects (e.g., other vehicles). In some such examples, a vehicle may adequately detect either slower-moving objects or faster-moving objects (but not both). As a result, scene flow estimation techniques may perform relatively poorly in some circumstances, such as in the presence of multiple different types of objects.

### BRIEF SUMMARY OF SOME EXAMPLES

In some aspects of the disclosure, an apparatus includes a processing system including one or more processors and one or more memories coupled to the one or more processors. The processing system is configured to receive a first point cloud representing a scene at a first time and to receive a second point cloud representing at least a portion of the scene at a second time after the first time. The first point cloud includes a point associated with a location within the first point cloud. The processing system is further configured to determine one or more first neighbor points within the second point cloud that are within a first radius of the location and to determine one or more second neighbor points within the second point cloud that are within a second radius of the location. The second radius is different than the first radius. The processing system is further configured to determine a multi-resolution flow embedding for the first point based on the one or more first neighbor points and the one or more second neighbor points and to generate a scene flow model associated with the scene based on the multi-resolution flow embedding.

In some other aspects, a method of operation of a device includes receiving a first point cloud representing a scene at a first time and receiving a second point cloud representing at least a portion of the scene at a second time after the first time. The first point cloud includes a point associated with a location within the first point cloud. The method further includes determining one or more first neighbor points within the second point cloud that are within a first radius of the location and determining one or more second neighbor points within the second point cloud that are within a second radius of the location. The second radius is different than the first radius. The method further includes determining a multi-resolution flow embedding for the first point based on the one or more first neighbor points and the one or more second neighbor points and generating a scene flow model associated with the scene based on the multi-resolution flow embedding.

In some other aspects, an apparatus includes a processing system including one or more processors and one or more memories coupled to the one or more processors. The processing system is configured to receive a point cloud representing a scene. The point cloud includes a point associated with a location within the point cloud. The processing system is further configured to identify a plurality of neighbor points that are within a particular radius of the location within the point cloud and to determine a plurality of flow feature vectors respectively associated with the plurality of neighbor points. The processing system is further configured to determine an attention metric associated with the plurality of flow feature vectors using an attention-based transformer of an artificial intelligence (AI) engine and to determine a flow feature associated with the point based on the attention metric.

In some other aspects, a method of operation of a device includes receiving a point cloud representing a scene. The point cloud includes a point associated with a location within the point cloud. The method further includes identifying a plurality of neighbor points that are within a particular radius of the location within the point cloud and determining a plurality of flow feature vectors respectively associated with the plurality of neighbor points. The method further includes determining an attention metric associated with the plurality of flow feature vectors using an attention-based transformer of an artificial intelligence (AI) engine and determining a flow feature associated with the point based on the attention metric.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

### BRIEF DESCRIPTION OF THE DRAWINGS

FIG. 1 is a perspective view of a vehicle with a monitoring system according to some aspects of the disclosure.

FIG. 2 shows a block diagram of an example image processing configuration for a vehicle according to some aspects of the disclosure.

FIG. 3 is a block diagram illustrating examples of scene flow estimation operations according to some aspects of the disclosure.

FIG. 4 is a diagram illustrating example features that may be associated with multi-resolution flow embedding according to some aspects of the disclosure.

FIG. 5 is a diagram illustrating example features that may be associated with a multi-position attention-based up-sampling (MPAU) process according to some aspects of the disclosure.

FIG. 6 is a flow chart illustrating an example method according to some aspects of the disclosure.

FIG. 7 is a flow chart illustrating another example method according to some aspects of the disclosure.

Like reference numbers and designations in the various drawings indicate like elements.

### DETAILED DESCRIPTION

In some aspects of the disclosure, multiple different scales may be used in connection with flow embedding in scene flow estimation. The multiple different scales may enable improved tracking of a target point over multiple frames as compared to other techniques, such as some scene flow estimation techniques that use a single scale for flow embedding. To illustrate, the multiple different scales may be associated with multiple respective radii. For each radius of the multiple radii, a set of neighbor points within the radius of the target point may be identified. Information associated with the sets of neighbor points may be aggregated to determine a multi-resolution flow embedding.

Such a multi-resolution flow embedding may facilitate improved performance in scene flow estimation as compared to other techniques, such as a single-resolution flow embedding technique. For example, using multiple different radii to detect motion between frames may enable detection of both large and small displacements between frames, enabling more robust and accurate flow estimation. As a result, in some examples, different types of objects may be better captured, including slower-moving objects (e.g., pedestrians) as well as faster-moving objects (e.g., other vehicles).

Alternatively or in addition to using performing multi-resolution flow embedding, in some aspects of the disclosure, multi-position attention-based up-sampling (MPAU) may be performed. Performing the MPAU may include combining flow features from points with similar motion or semantic meaning. For example, an artificial intelligence (AI) engine may use attention-based weightings to weight the association of neighbor points to one another. In some examples, more relevant neighboring points may be adaptively selected (e.g., instead of selecting neighboring points using a fixed radius), increasing robustness to variations in density or sampling variations in a point cloud (e.g., as compared to a fixed radius search).

In some examples, an input to an MPAU block of the AI engine may include a flow embedding of a target point as well as K neighbor points of the target points. An output of the MPAU block may include an updated flow embedding for the target point. The output of the MPAU block may aggregate information from neighbor points based on learned attention weights.

Use of the MPAU may improve performance associated with scene flow estimation. For example, the MPAU block may adaptively learn to identify features that are semantically related or that exhibit similar motion (and thus may likely belong to the same object). As a result, performance may be improved, such as by better preserving scene details at the boundaries between objects.

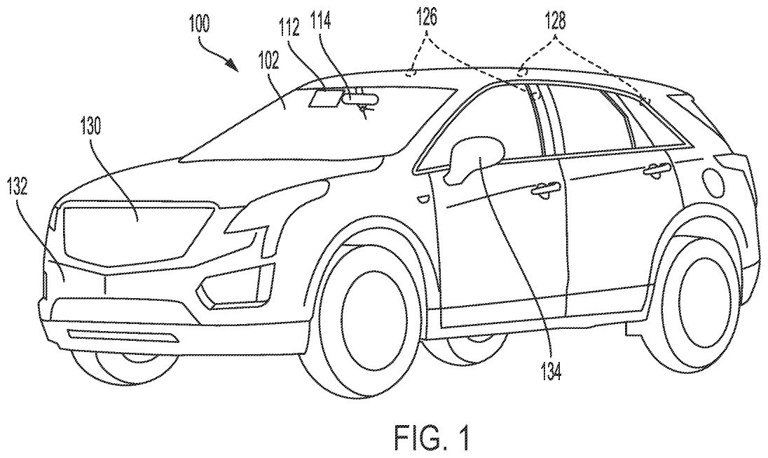

FIG. 1 is a perspective view of a vehicle 100 that may include a monitoring system according to some aspects of the disclosure. The vehicle 100 may include a front-facing camera 112 mounted inside the cabin looking through the windshield 102. The vehicle may also include a cabin-facing camera 114 mounted inside the cabin. In some implementations, the cabin-facing camera 114 may be oriented toward occupants of the vehicle 100 (e.g., toward a driver of the vehicle 100). Although one set of mounting positions for cameras 112 and 114 are shown for vehicle 100, other mounting locations may be used for the cameras 112 and 114. For example, one or more cameras may be mounted on one of the B pillars 126 or one of the C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

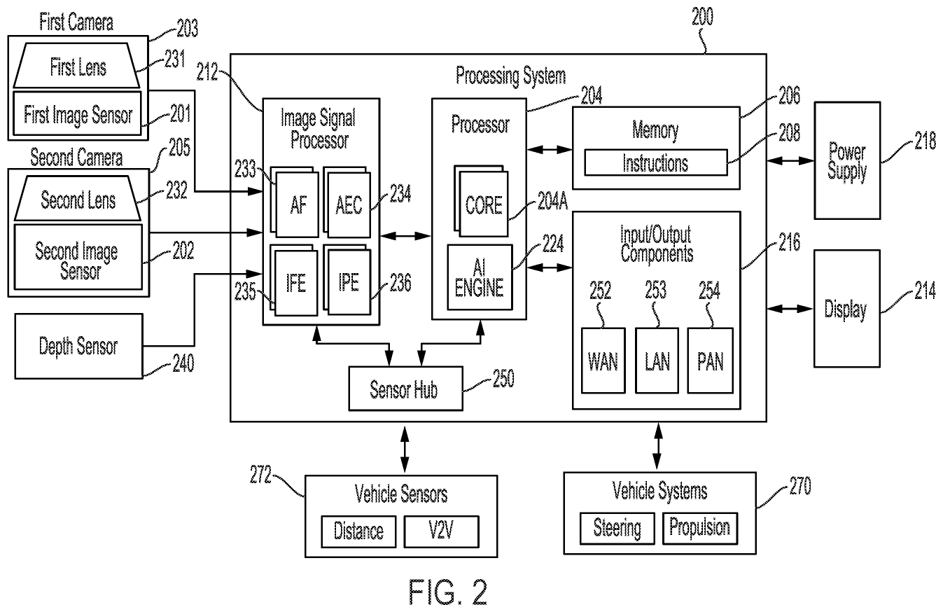

FIG. 2 shows a block diagram of an example image processing configuration for a vehicle according to some aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor 204 (e.g., a CPU) and a memory 206 storing instructions 208. The vehicle 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package. In some examples, one or more components described with reference to FIG. 2 may be included in a processing system 200, which may include or correspond to the SoC.

In some embodiments, at least one of the image signal processor 212 or the processor 204 executes instructions to perform various operations described herein, such as object detection, risk map generation, driver monitoring, and driver alert operations. For example, execution of the instructions can instruct the image signal processor 212 to begin or end capturing an image frame or a sequence of image frames. In some embodiments, the processor 204 may include one or more processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 214 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

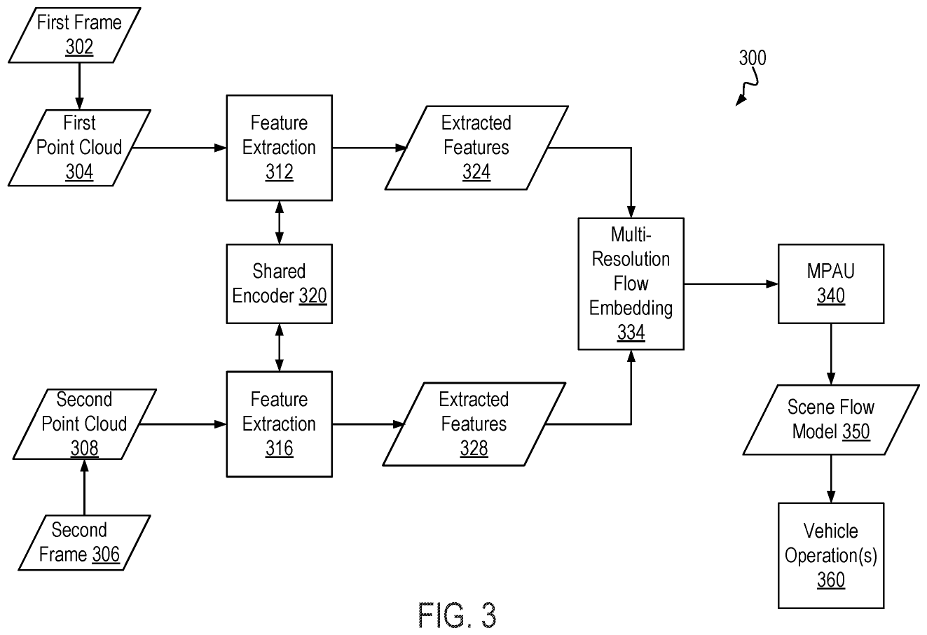

FIG. 3 is a block diagram illustrating examples of scene flow estimation operations 300 according to some aspects of the disclosure. In some examples, the scene flow estimation operations 300 may be performed by the vehicle 100.

The operations may include receiving a first frame 302 associated with a scene at a first time and receiving a second frame 306 associated with at least a portion of the scene at a second time. To illustrate, in some examples, the vehicle sensors 272 may generate the first frame 302 and the second frame 306. In some examples, the vehicle sensors 272 may include a light detection and ranging (LiDAR) system that generates the first frame 302 and the second frame 306. The first frame 302 and the second frame 306 may be consecutive frames.

The scene flow estimation operations 300 may include generating first point cloud 304 and generating a second point cloud 308. The first point cloud 304 may represent the scene at the first time, and the second point cloud 308 may represent at least a portion of the scene at the second time after the first time. The vehicle 100 may determine the first point cloud 304 based on the first frame 302 and may determine the second point cloud 308 based on the second frame 306. For example, the first point cloud 304 may correspond to a three-dimensional (3D) representation of the scene at the first time, and the second point cloud 308 may correspond to a 3D representation of at least a portion of the scene at the second time.

The scene flow estimation operations 300 may further include performing feature extraction 312 associated with the first point cloud 304 and performing feature extraction 316 associated with the second point cloud 308. In some examples, the feature extraction 312, 316 may be performed using a shared encoder 320. Performing the feature extraction 312 may generate extracted features 324 of the first point cloud 304. Performing the feature extraction 316 may generate extracted features 328 of the second point cloud 308.

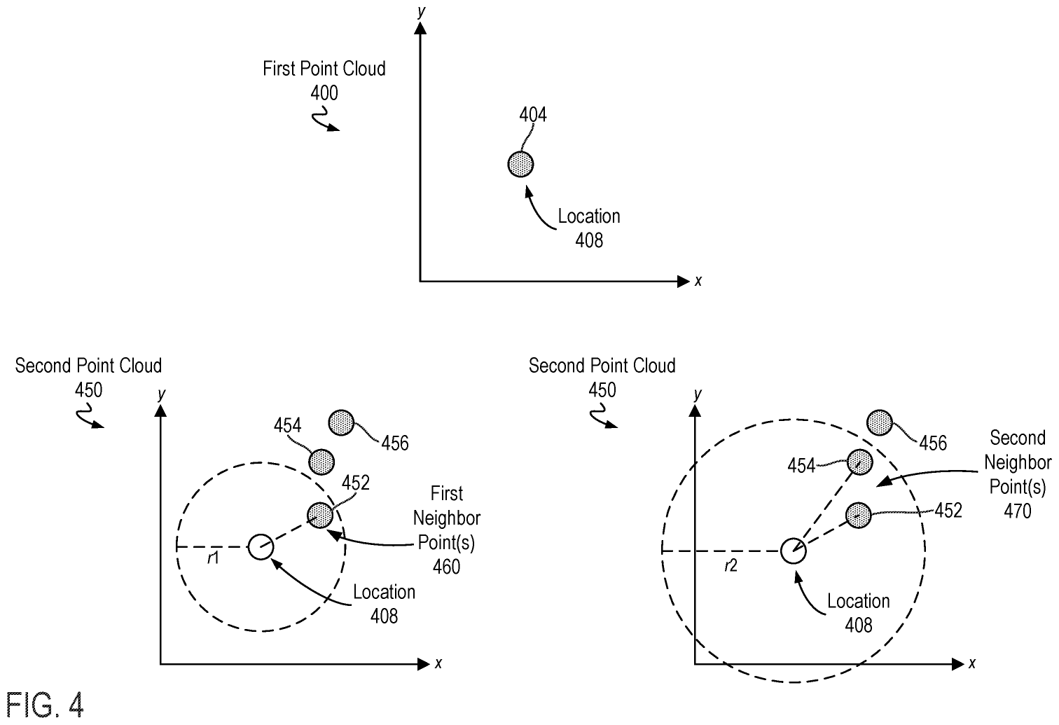

The scene flow estimation operations 300 may further include determining a multi-resolution flow embedding 334 based on the extracted features 324 and the extracted features 328. Some illustrative examples that may be associated with the multi-resolution flow embedding 334 are described further with reference to FIG. 4.

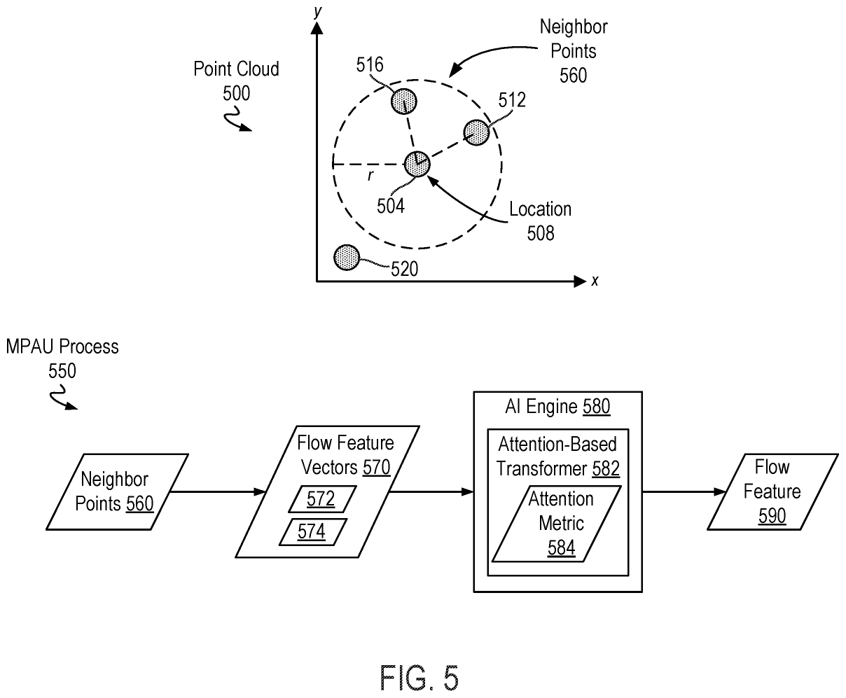

The scene flow estimation operations 300 may further include performing multi-position attention-based up-sampling (MPAU) 340. Some illustrative examples that may be associated with the MPAU 340 are described further with reference to FIG. 5.

The scene flow estimation operations 300 may further include determining a scene flow model 350 based on the MPAU 340. In some examples, the scene flow model 350 may be a three-dimensional (3D) scene flow model.

The scene flow estimation operations 300 may further include initiating one or more operations associated with the vehicle 100, such as one or more vehicle operations 360. In some examples, performing the one or more vehicle operations 360 may include generating an alert. To illustrate, if the scene flow model 350 indicates an obstacle or a potential collision, the vehicle 100 may generate an auditory alert, a visual alert, or both. Alternatively, or in addition, in some autonomous or semi-autonomous implementations of the vehicle 100, the one or more vehicle operations 360 may include a steering operation, a braking operation, one or more other operations, or a combination thereof.

FIG. 4 is a diagram illustrating example features that may be associated with multi-resolution flow embedding according to some aspects of the disclosure. One or more features of FIG. 4 may be described with reference to a first point cloud 400 and a second point cloud 450. In some examples, the first point cloud 400 may correspond to the first point cloud 304 of FIG. 3, and the second point cloud 450 may correspond to the second point cloud 308 of FIG. 3. In some examples, the operations described with reference to FIG. 4 may be performed in connection with the multi-resolution flow embedding 334 of FIG. 3. Although the first point cloud 400 and the second point cloud 450 may be illustrated in two dimensions (e.g., an x-direction and a y-direction), the first point cloud 400 and the second point cloud 450 may each correspond to a 3D model of a scene (and may further include a z-direction).

In the first point cloud 400, a point 404 may be associated with a location 408 (e.g., a particular set of coordinate values). In some examples, the point 404 may be referred to as a target point.

In the second point cloud 450, the point 404 may be associated with a different location relative to the first point cloud 400. For example, FIG. 4 illustrates that the point 404 may be present at the location 408 within the first point cloud 400 and that no point may be present at the location 408 in the second point cloud 450 (e.g., due to movement of the vehicle 100, movement of an object represented by the point 404, or a combination thereof). As a result, in the second point cloud 450, the point 404 may correspond to cither a point 452, a point 454, or a point 456.

In some aspects of the disclosure, the vehicle 100 may determine the multi-resolution flow embedding 334 using multiple different radii, such as a first radius r1 and a second radius r2. In some aspects, determining the multi-resolution flow embedding 334 using multiple different radii may increase the likelihood of tracking movement of the point 404 for different types of objects, which may have different speeds (e.g., where a pedestrian may travel slower than bicycle, and where a bicycle may travel slower than a vehicle).

The vehicle 100 may determine one or more first neighbor points 460 within the second point cloud 450 that are within the first radius r1 of the location 408. In the example of FIG. 4, the one or more first neighbor points 460 may include the point 452. In this case, a distance from the location 408 to the point 452 may be less than the first radius r1. In the example of FIG. 4, the one or more first neighbor points 460 may exclude the point 454 and the point 456.

The vehicle 100 may further determine one or more second neighbor points 470 within the second point cloud 450 that are within the second radius r2 of the location 408. In the example of FIG. 4, the one or more second neighbor points 470 may include the point 452 and the point 454. In this case, a distance from the location 408 to the point 452 may be less than the second radius r2, and a distance from the location 408 to the point 454 may also be less than the second radius r2, In the example of FIG. 4, the one or more second neighbor points 470 may exclude the point 456.

To further illustrate, the second radius r2 may be greater than the first radius r1, and the one or more second neighbor points 470 include at least one point not included in the one or more first neighbor points 460. In the example of FIG. 4, the at least one point may correspond to the point 454.

To further illustrate, the multi-resolution flow embedding 334 may be determined using multiple radii r1, r2, . . . , rN, such as by selecting at least one neighbor point of the point 404 within the second point cloud 450 in accordance with Equation 1:

$${p}_{2 i} \vert d ( {p}_{1} , {p}_{2 i} ) < ri \} , for i = 1 to N . \qquad ( Equation 1 )$$

In the example of Equation 1, p₁ may represent the point 404, p₂ᵢ may represent the ith point of the second point cloud 450, d (p₁,p₂ᵢ) may indicate the distance between the point 404 and the ith point of the second point cloud 450. N may indicate a positive integer greater than one (N≥2), and ri may indicate the ith radius of the multiple radii r1, r2, . . . , rN. Accordingly, a respective set of one or more neighbor points may be determined for each radius of the multiple radii r1, r2, . . . , rN.

In some examples, the multi-resolution flow embedding 334 may be determined in accordance with Equation 2:

$$f ( {p}_{1} ) = {\sum }_{i = 1}^{N} {g}_{i} ( {p}_{1} , {p}_{2 i} ) . \qquad ( Equation 2 )$$

In the example of Equation 2, f(p₁) may refer to the multi-resolution flow embedding 334, and g may refer to a learnable function of an artificial intelligence (AI) engine (e.g., the AI engine 224). Each gᵢ may be referred to herein as an ith motion encoding value and may be determined based on the learnable function g of the AI engine (e.g., by evaluating g based on i).

To illustrate, for the first radius r1 (where i=1), the vehicle 100 may determine a first motion encoding value g₁ based on p₁ (e.g., the point 404) and further based on p₂ᵢ (e.g., the one or more first neighbor points 460). For the second radius r2 (where i=2), the vehicle 100 may determine a second motion encoding value g₂ based on p₁ (e.g., the point 404) and further based on p₂ᵢ (e.g., the one or more second neighbor points 470).

In accordance with example of Equation 2, determining the multi-resolution flow embedding 334 may include summing the motion encoding values for i=1, . . . . N. As an illustrative example, if N=2, then the first motion encoding value g₁ and the second motion encoding value g₂ may be summed to determine the multi-resolution flow embedding 334.

To further illustrate, in some examples, a geometry-aware scene flow estimation process may be performed in connection with multi-resolution flow embedding. The geometry-aware scene flow estimation process may include receiving multiple point clouds, such as consecutive LiDAR point clouds. In some examples, the point clouds may correspond to the point clouds 304, 308 or the point clouds 400, 450. The point clouds may include a first point cloud (P1) and a second point cloud (P2).

The geometry-aware scene flow estimation process may further include down-sampling the point clouds to generate a first down-sampled point cloud (P1_{ds}) and a second down-sampled point cloud (P2_{ds}). The geometry-aware scene flow estimation process may further include learning deep point cloud features for each frame individually using one or more set convolution (conv) layers or using a set abstraction layer, as illustrative examples.

The geometry-aware scene flow estimation process may further include performing flow embedding learning with correspondence searches using multiple radii (e.g., r1 and r2 in the example of FIG. 4, one or more other radii, or a combination thereof) around each point of the first point cloud. In some examples, performing the flow embedding learning may include generating candidate correspondences at different ranges in the second point cloud. In some examples, the geometry-aware scene flow estimation process may be performed in accordance with the illustrative pseudo-code of Example 1:

### Example 1

```
For each point p₁ in P1_{ds}:
      For radius ri, i=1 to r=N:
            Find correspondences: p₂ᵢ = p₂:d(p₁,p₂) < ri ⊂ P2_{ds}
                  //d(p₁,p₂) is the distance between p₁ and p₂
                  //ri is the ith radius value
                  //p₂ᵢ is the set of points in P2_{ds} within radius ri of p₁
                  //⊂ indicates a subset
```

Accordingly, the subset of points p₂ᵢ in P2_{ds} that are within a radius ri of the point p₁ in P1_{ds} may be identified. For each radius of the multiple radii, motion embedding features may be computed in accordance with gᵢ=G (p₁, p2ᵢ, f₁, f₂). In some examples, G may represent a non-linear function with trainable parameters, such as one or more set convolution (conv) layers. In some examples, each f may be determined in accordance with one or more set conv layers or in accordance with one or more set abstraction layers. To illustrate, in some examples, f₁=F (P1_{das}) and f₂=F (P2_{ds}), where F may indicate a function associated with one or more set conv layers or one or more set abstraction layers.

The geometry-aware scene flow estimation process may further include passing candidate features associated with each radius (also referred to herein as a scale or neighborhood) to a multi-layer perception (MLP) model to obtain attention weights. The geometry-aware scene flow estimation process may further include performing a softmax operation (also referred to as a normalized exponential operation or softmax activation operation) over the attention weights at each scale.

The geometry-aware scene flow estimation process may also include generating a weighted sum of the candidate features at each scale using the computed attention, which may produce the aggregated correspondences from all scales. The geometry-aware scene flow estimation process may also include concatenating the aggregated correspondences into a correspondence vector for p, such as in accordance with h=[p₁, g].

The geometry-aware scene flow estimation process may further include providing the correspondence vector through one or more additional MLP models to predict a refined flow for p, such as in accordance with Δp₁=MLP(h). Further, Δp₁ may be up-sampled, such as by upsampling flow embeddings associated with the intermediate points to the original points, and flow may be predicted at the last layer flow for the original points.

Some implementations may use multi-scale cross flow attention embedding (MSCAE) block in connection with multi-resolution flow embedding. To illustrate, for each individual point, an input to the MSCAE block may include several different corresponding flow embedding features, such as various different radii. The input to a transformer (such as a transformer of an AI engine) may be zᵣ= [zᵣ₁, zᵣ₂], where zᵣ₁ may indicate the flow feature vector for a point p with radius r1, and where zᵣ₂ may indicate the flow feature vector for the same point p with radius r2 with radius r2. After modeling element-wise interactions among those features for each point separately, the output from the MSCAE block may include the updated feature vectors after aggregating the information for multiple different radii (also referred to as scales or neighborhoods).

In some implementations, cross-scale attention between flow embeddings may be determined in accordance with Example 2:

$${a}_{ij} = Softmax ( {W}_{q} {z}_{r}^{T} , {W}_{k} {z}_{r} ) \qquad Example 2$$

In Example 2, αᵢⱼ may indicate an attention weight (e.g., the ith, jth coefficient in an attention matrix) between a radius r1-based embedding zᵣ₁ and a radius r2-based embedding zᵣ₂. In some implementations, W_{q} and Wₖ may represent linear projection matrices (e.g., where W_{g}, Wₖ∈R of C×C, and where C may represent a flow feature vector dimension). A softmax operation may be applied to generate normalized attention weights. Accordingly, αᵢⱼ may indicate or may be associated with a strength of correspondence between each radius-pair (e.g., where r1 and r2 correspond to one radius pair).

In some examples, a transformer encoder may incorporate contextual information from multiple neighboring points for each feature vector through self-attention. This attended encoding may capture relationships within each neighborhood. This joint cross flow embedding approach with attention may enable the model to learn correspondence focused representations capturing relationships within and across neighborhood in a more explicit manner. The attention may guide both embedding learning and later fusion. This fused attended embedding may encapsulate relationships learned by the MSCAE block for downstream tasks.

Accordingly, the MSCAE block may embed multi-scale neighborhood flow embeddings into a shared latent space to learn robust correspondences. Cross attention may be used to weight how much neighborhood flow embeddings “attend to” one another. Attention may be used to guide the embedding projection. The attention-based mechanism may be implemented in an end-to-end trainable block to enable learning displacement focused representations in an explicit, attention guided manner. The MSCAE block may receive multi-range inputs (e.g., long-range and short-range flow embeddings) and may use cross-attention between embeddings. As a result, the MSCAE block may use attention mechanisms to learn joint embeddings for multi-range point correspondence.

In some aspects, multi-resolution flow embedding may achieve one or more of the following benefits. In some examples, multi-range displacements may be captured. For example, by aggregating correspondences across different radii, both large and small motions may be estimated. Multi-resolution flow embedding may be relatively robust to varied motion. For example, multi-scale aggregation may make the flow estimation more robust to different displacement magnitudes in a scene. Attention weighting and learned attention may be used to filter and weight correspondences based on feature similarities, which may enable selectively fusing of relevant matches. Overall flow accuracy may be improved as compared to other techniques, such as a single-scale technique. Reduced hyperparameters may be needed as the model learns to combine different ranges, which may involve less manual tuning of parameters such as radius size. Object-level motion priors may be incorporated during a multi-scale correspondence search. Non-uniform motion may be handled by learning to aggregate flows from regions with diverse motion patterns. Efficient computation may be enabled by focusing on large motion areas and by optionally ignoring static regions. Multi-scale information may be implemented using an end-to-end learnable framework with automatic multi-scale fusion. Information may be propagated across scales during flow refinement, and relationships may be modeled between multi-scale embeddings using cross-attention. Accordingly, multi-resolution flow embedding may provide an end-to-end learnable technique to fuse motion information across varied scales and displacements, which may improve accuracy, robustness, and flexibility of flow estimation, with less need for parameter tuning.

Alternatively or in addition to performing multi-resolution flow embedding (such as the multi-resolution flow embedding 334), in some aspects of the disclosure, a framework for 3D scene flow may use multiple frames as input, including the use of a scene flow backbone and a multi-position attention-based up-sampling (MPAU) layer. In some examples, the MPAU layer may combine selected flow features, such as flow features from points with similar motion or semantic meaning.

To illustrate, the vehicle 100 may include or may execute instructions of a scene flow estimation pipeline, which may correspond to the scene flow estimation operations 300 of FIG. 3. In the scene flow estimation pipeline, individual frame features and initial scene flow estimates may be determined for multiple frames (such as consecutive LiDAR frames). In some examples, the multiple frames may include the first frame 302 and the second frame 306. The MPAU layer may operate using a multi-resolution flow embedding (such as the multi-resolution flow embedding 334) or using another type of flow embedding, such as a single-resolution flow embedding.

In some examples, the MPAU layer may up-sample extracted flow features and may project the up-sampled flow features to a point cloud coordinate space. The point cloud coordinate space may be associated with any of the point clouds 304, 308, 400, and 450.

The MPAU layer may pass the projected flow features to one or more self-attention layers. The one or more self-attention layers may be associated with attention weights, which may automatically connect points with similar flow embeddings, which may correspond to features with the same motion or the same semantic meaning, and which may therefore be associated with (or may be likely to be associated with) the same object. Each up-sampled point may attend over multiple positions in a preceding layer, and attended features may be aggregated to produce an output flow feature associated with the up-sampled point. Some illustrative examples that may be associated with the MPAU layer are described further with reference to FIG. 5.

FIG. 5 is a diagram illustrating example features that may be associated with a point cloud 500 and a multi-position attention-based up-sampling (MPAU) process 550 according to some aspects of the disclosure. The point cloud 500 may correspond to the first point cloud 304, the second point cloud 308, the first point cloud 400, the second point cloud 450, or another point cloud. In some examples, the MPAU process 550 may correspond to the MPAU 340 of FIG. 3. Although the point cloud 500 may be illustrated in two dimensions (e.g., an x-direction and a y-direction), the point cloud 500 may correspond to a 3D model of a scene (and may further include a z-direction).

The point cloud 500 may include a point 504 associated with a location 508 within the point cloud 500. In some examples, the point 504 may be referred to as a target point. The point cloud 500 may also include one or more other points, such as a point 512, a point 516, and a point 520.

The vehicle 100 may identify neighbor points 560 that are within a particular radius r of the location 508. In some examples, the radius r may correspond to the radius r1 of FIG. 4, the radius r2 of FIG. 4, or another radius. In the example of FIG. 5, the neighbor points 560 may include the point 512 and the point 516. In the example of FIG. 5, the neighbor points 560 may exclude the point 520.

The MPAU process 550 may include determining flow feature vectors 570 respectively associated with the neighbor points 560. The flow feature vectors 570 may represent objects associated with a scene represented by the point cloud 500. For example, the flow feature vectors 570 may include a first flow feature vector 572 associated with a first object of the scene. As another example, the flow feature vectors 570 may include a second flow feature vector 574 associated with a second object of the scene different than the first object.

The MPAU process 550 may further include inputting the flow feature vectors 570 to an AI engine 580. In some examples, the AI engine 580 may correspond to the AI engine 224 of FIG. 2, the AI engine described with reference to FIG. 4, or another AI engine.

The MPAU process 550 may further include determining an attention metric 584 associated with the flow feature vectors 570 using an attention-based transformer 582 of the AI engine 580. In some examples, the attention metric 584 may also be referred to as a self-attention metric or as a cross-attention metric. For example, in some implementations, the attention metric 584 may be based at least in part on cross-attention between the first flow feature vector 572 and the second flow feature vector 574.

To further illustrate, the attention-based transformer 582 may include or may be associated with an attention layer. In some examples, an input to the attention layer may be in accordance with Equation 3:

$${z}_{r} = [ f ( {p}_{s 1} ) , f ( {p}_{s 2} ) , … , f ( {p}_{sK} ) ] . \qquad ( Equation 3 )$$

In Equation 3, zᵣ may correspond to the input to the attention layer, pₛᵢ may indicate the ith neighbor point of pt, and f(pₛᵢ) may indicate a D-dimensional flow feature vector for the ith neighbor point, where D indicates a positive integer. In some examples, the attention layer may be associated a set of queries Q, a set of keys K, and a set of values V. The set of queries Q may be associated with flow features of pt (e.g., the point 504), and the set of keys K may be associated with flow features of the neighbor points of pt. In some examples, the attention-based transformer 582 may determine a dot product, such as in accordance with Equation 4:

$$A = {QK}^{T} / √ D . \qquad ( Equation 4 )$$

In Equation 4, T may indicate a transverse operator, and A may indicate an attention matrix. Evaluating Equation 4 may include determining a dot product of each query Q with each key K scaled by the square root of the dimension D. Further, the attention matrix A may be referred to as a “raw” attention score. The raw attention score may be input to a softmax operation (also referred to as a normalized exponential operation or softmax activation operation), such as in accordance with Equation 5:

$$a = softmax ( A ) . \qquad ( Equation 5 )$$

In the example of Equation 5, & may represent an attention weight, such as an attention weight between points i and j, where points i and j may be included in a set of points that includes pt and ps. In some examples, the result of evaluating Equation 5 may correspond to a weighted sum of values, such as in accordance with Equation 6:

$$Z = aV . \qquad ( Equation 6 )$$

In Equation 6, Z may represent an updated D-dimensional flow feature for the target point pt and may aggregate information from neighbor points using learned attention weights. V may represent the set of values V.

Alternatively, or in addition, in some examples, the attention metric 584 may be determined in accordance with Equation 7:

$$ATT ( [ f ( {p}_{s 1} ) , f ( {p}_{s 2} ) , … , ( {p}_{sK - 1} ) , f ( {p}_{sK} ) ] \} , \qquad ( Equation 7 )$$

$$where {p}_{s} : d ( {p}_{t} , {p}_{s} ) < r .$$

In Equation 7, Att may represent an attention function (e.g., an attention matrix), and evaluating the attention function Att may yield the attention metric 584. Further, pₜ may represent the point 504, and pₛ may represent the neighbor points 560, where Psi may indicate the ith point of the neighbor points 560. In addition, d(pₜ,pₛ) may represent a distance between pₜ and pₛ. Each f(pₛᵢ) may represent the ith flow feature vector of the flow feature vectors 570. In Equation 7, K may represent a quantity of neighbor points of pₜ. To illustrate, in the example illustrated in FIG. 5, K may correspond to two. Other examples are also within the scope of the disclosure.

The MPAU process 550 may further include determining a flow feature 590 associated with the point 504 based on the attention metric 584. In some examples, determining the flow feature 590 may include identify a maximum (max) value from among different values of the attention metric 584. To further illustrate, in some examples, the flow feature 590 may be determined in accordance with Equation 8:

$$( Equation 8 )$$

$$f ( {p}_{t} ) = MAX \{ Att ( [ f ( {p}_{s 1} ) , f ( {p}_{s 2} ) , … , f ( {p}_{sK - 1} ) , f ( {p}_{sK} ) ] ) \} ,$$

$$where {p}_{s} : d ( {p}_{t} , {p}_{s} ) < r .$$

In Equation 8, f(pₜ) may represent the flow feature 590, and MAX may indicate a maximum function. In addition, Att may represent an attention function (e.g., an attention matrix), and evaluating the attention function Att may yield the attention metric 584.

To further illustrate, in some aspects, multi-position neighborhood flow embeddings may be embedded into a shared latent space to automatically learn robust object-level information, which may be performed in connection with up-sampling. Further, cross-attention may be used to determine an amount that a flow embedding of a neighbor point “attends” to a flow embedding of another neighbor point. For example, weights associated with the cross-attention may be selected to enable the amount of attention.

In some examples, adaptive attention and object-level information may be used to identify boundaries or edge points based on distances and flow features. More relevant neighboring points may be adaptively selected (e.g., instead of selecting neighboring points using a fixed radius), increasing robustness to variations in density or sampling variations in a point cloud (e.g., as compared to a fixed radius search). Relationships between neighbor points may be analyzed simultaneously (e.g., instead of analyzing each such point independently), which may facilitate capture of richer content in some cases.

In some examples, an attention-based mechanism may be implemented in an end-to-end trainable block to enable learning of semantic representations in an attention-guided manner. For example, the AI engine 580 may correspond to an end-to-end trainable block that learns semantic representations in an attention-guided manner.

Accordingly, an MPAU block (such as the MPAU 340) may utilize cross-attention between multi-position flow embedding inputs (e.g., different flow embeddings belonging to different objects). As a result, the MPAU block may learn joint embeddings for a multi-position point flow (e.g., during an up-sampling stage of scene flow estimation). Inputs to the MPAU block may include a flow embedding of a target point as well as flow embeddings of K neighbor points of the target point. Such inputs may serve as queries, keys, and values for determination of self-attention.

Using cross-attention, the MPAU block may simultaneously model pairwise relations of input points (such as points of the point cloud 500). As a result, the MPAU block may capture relationships between points, such as points that may (or may not) be associated with the same object in a scene.

An output of the MPAU block may include an updated flow embedding for the target point. The output of the MPAU block may include, based on learned attention weights, aggregated information associated with neighbor points of the target point. The updated flow embedding may be inserted after a scene flow embedding learning module and during up-sampling. The MPAU block may guide the combining of features from multiple positions in an object-aware manner, which may improve performance as compared to other techniques, such as a fixed-radius search.

Further, by attending to points farther than just nearest neighbors of the target point, longer-range dependencies may be captured (which may depend on the quantity of neighbor points K). Training of the MPAU block may be performed in an end-to-end manner with the rest of the model, which may improve scene flow prediction through gradients in some examples. As a result, object-focused up-sampling may be performed (e.g., instead of treating each point independently), which may improve performance, such as by better preserving scene details at the boundaries between objects. Accordingly, in some aspects, the MPAU block may use self-attention to learn joint embeddings, which may incorporate relationships between input points for robust multi-position flow up-sampling.

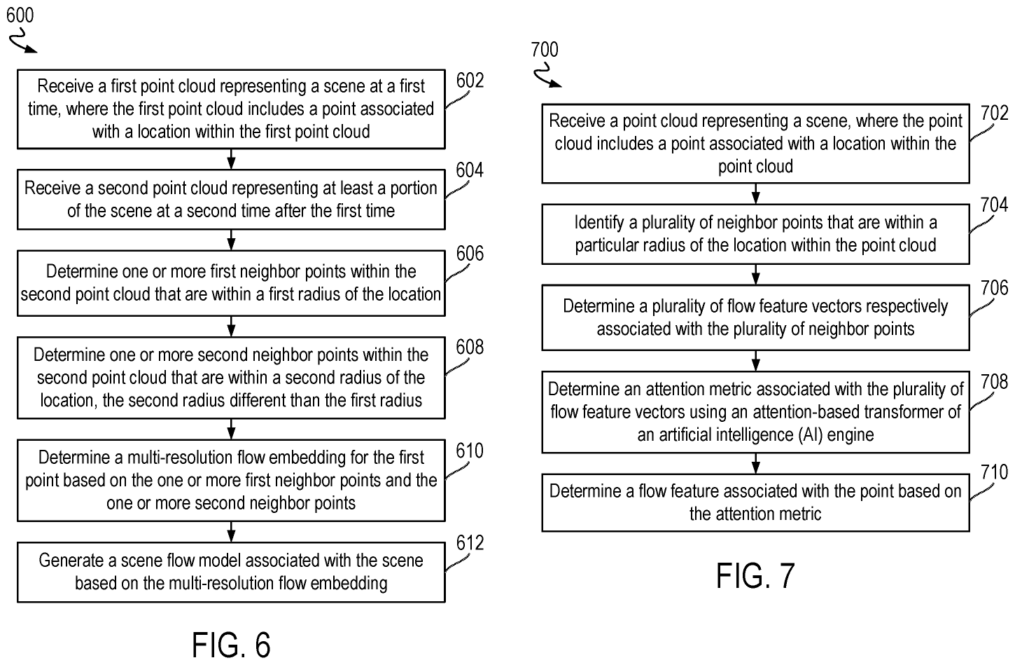

FIG. 6 is a flow chart illustrating an example method 600 according to some aspects of the disclosure. In some examples, the vehicle 100 may perform the method 600. For example, the processor 204 may initiate, control, or perform one or more operations of the method 600.

The method 600 may include receiving a first point cloud representing a scene at a first time, at 602. The first point cloud includes a point associated with a location within the first point cloud. To illustrate, the first point cloud may correspond to the first point cloud 304, the first point cloud 400, or the first point cloud P1. In some examples, the point may correspond to the point 404, and the location may correspond to the location 408.

The method 600 may further include receiving a second point cloud representing at least a portion of the scene at a second time after the first time, at 604. To illustrate, the second point cloud may correspond to the second point cloud 308, the second point cloud 450, or the second point cloud P2.

The method 600 may further include determining one or more first neighbor points within the second point cloud that are within a first radius of the location, at 606. To illustrate, the one or more first neighbor points may correspond to the one or more first neighbor points 460, and the first radius may correspond to the first radius r1.

The method 600 may further include determining one or more second neighbor points within the second point cloud that are within a second radius of the location, at 608. The second radius is different than the first radius. To illustrate, the one or more second neighbor points may correspond to the one or more second neighbor points 470, and the second radius may correspond to the second radius r2.

The method 600 may further include determining a multi-resolution flow embedding for the first point based on the one or more first neighbor points and the one or more second neighbor points, at 610. For example, the multi-resolution flow embedding may correspond to the multi-resolution flow embedding 334.

The method 600 may further include generating a scene flow model associated with the scene based on the multi-resolution flow embedding, at 612. For example, the scene flow model may correspond to the scene flow model 350.

FIG. 7 is a flow chart illustrating an example method 700 according to some aspects of the disclosure. In some examples, the vehicle 100 may perform the method 700. For example, the processor 204 may initiate, control, or perform one or more operations of the method 700.

The method 700 may include receiving a point cloud representing a scene, at 702. The point cloud includes a point associated with a location within the point cloud. To illustrate, the point cloud may correspond to the first point cloud 304, the second point cloud 308, the first point cloud 400, the second point cloud 450, the point cloud 500, the first point cloud P1, or the second point cloud P2. In some examples, the point may correspond to the point 504, and the location may correspond to the location 508.

The method 700 may further include identifying a plurality of neighbor points that are within a particular radius of the location within the point cloud, at 704. For example, the plurality of neighbor points may include or correspond to the neighbor points 560.

The method 700 may further include determining a plurality of flow feature vectors respectively associated with the plurality of neighbor points, at 706. For example, the plurality of flow feature vectors may include or correspond to the flow feature vectors 570.

The method 700 may further include determining an attention metric associated with the plurality of flow feature vectors using an attention-based transformer of an artificial intelligence (AI) engine, at 708. For example, the attention-based transformer may correspond to the attention-based transformer 582, the AI engine may correspond to the AI engine 580, and the attention metric may correspond to the attention metric 584.

The method 700 may further include determining a flow feature associated with the point based on the attention metric, at 710. For example, the flow feature may correspond to the flow feature 590.

In some examples, the method 700 may further include generating a scene flow model associated with the scene based on the flow feature. For example, the scene flow model may correspond to the scene flow model 350.

In a first aspect, an apparatus includes a processing system including one or more processors and one or more memories coupled to the one or more processors. The processing system is configured to receive a first point cloud representing a scene at a first time and to receive a second point cloud representing at least a portion of the scene at a second time after the first time. The first point cloud includes a point associated with a location within the first point cloud. The processing system is further configured to determine one or more first neighbor points within the second point cloud that are within a first radius of the location and to determine one or more second neighbor points within the second point cloud that are within a second radius of the location. The second radius is different than the first radius. The processing system is further configured to determine a multi-resolution flow embedding for the first point based on the one or more first neighbor points and the one or more second neighbor points and to generate a scene flow model associated with the scene based on the multi-resolution flow embedding.

In a second aspect, in combination with the first aspect, the processing system is further configured to determine a first motion encoding value based on the point and the one or more first neighbor points and to determine a second motion encoding value based on the point and the one or more second neighbor points.

In a third aspect, in combination with one or more of the first aspect or the second aspect, the processing system further includes an artificial intelligence (AI) engine configured to determine the first motion encoding value and the second motion encoding value based on a learnable function.

In a fourth aspect, in combination with one or more of the first aspect through the third aspect, the processing system is further configured to sum the first motion encoding value and the second motion encoding value to determine the multi-resolution flow embedding.

In a fifth aspect, in combination with one or more of the first aspect through the fourth aspect, the second radius is greater than the first radius, and the one or more second neighbor points include at least one point not included in the one or more first neighbor points.

In a sixth aspect, in combination with one or more of the first aspect through the fifth aspect, the processing system is further configured to initiate one or more operations associated with a vehicle based on the scene flow model.

In a seventh aspect, a method of operation of a device includes receiving a first point cloud representing a scene at a first time and receiving a second point cloud representing at least a portion of the scene at a second time after the first time. The first point cloud includes a point associated with a location within the first point cloud. The method further includes determining one or more first neighbor points within the second point cloud that are within a first radius of the location and determining one or more second neighbor points within the second point cloud that are within a second radius of the location. The second radius is different than the first radius. The method further includes determining a multi-resolution flow embedding for the first point based on the one or more first neighbor points and the one or more second neighbor points and generating a scene flow model associated with the scene based on the multi-resolution flow embedding.

In an eighth aspect, in combination with the seventh aspect, the method further includes determining a first motion encoding value based on the point and the one or more first neighbor points and determining a second motion encoding value based on the point and the one or more second neighbor points.

In a ninth aspect, in combination with one or more of the seventh aspect through the eighth aspect, the first motion encoding value and the second motion encoding value are determined based on a learnable function of an artificial intelligence (AI) engine.

In a tenth aspect, in combination with one or more of the seventh aspect through the ninth aspect, the method further includes summing the first motion encoding value and the second motion encoding value to determine the multi-resolution flow embedding.

In an eleventh aspect, in combination with one or more of the seventh aspect through the tenth aspect, the second radius is greater than the first radius, and the one or more second neighbor points include at least one point not included in the one or more first neighbor points.

In a twelfth aspect, in combination with one or more of the seventh aspect through the eleventh aspect, the method further includes initiating one or more operations associated with a vehicle based on the scene flow model.

In a thirteenth aspect, an apparatus includes a processing system including one or more processors and one or more memories coupled to the one or more processors. The processing system is configured to receive a point cloud representing a scene. The point cloud includes a point associated with a location within the point cloud. The processing system is further configured to identify a plurality of neighbor points that are within a particular radius of the location within the point cloud and to determine a plurality of flow feature vectors respectively associated with the plurality of neighbor points. The processing system is further configured to determine an attention metric associated with the plurality of flow feature vectors using an attention-based transformer of an artificial intelligence (AI) engine and to determine a flow feature associated with the point based on the attention metric.

In a fourteenth aspect, in combination with the thirteenth aspect, the plurality of flow feature vectors include a first flow feature vector associated with a first object of the scene and further include a second flow feature vector associated with a second object of the scene different than the first object.

In a fifteenth aspect, in combination with one or more of the thirteenth aspect through the fourteenth aspect, the attention metric is based at least in part on cross-attention between the first flow feature vector and the second flow feature vector.

In a sixteenth aspect, in combination with one or more of the thirteenth aspect through the fifteenth aspect, the processing system is further configured to initiate one or more operations associated with a vehicle based on the flow feature.

In a seventeenth aspect, a method of operation of a device includes receiving a point cloud representing a scene. The point cloud includes a point associated with a location within the point cloud. The method further includes identifying a plurality of neighbor points that are within a particular radius of the location within the point cloud and determining a plurality of flow feature vectors respectively associated with the plurality of neighbor points. The method further includes determining an attention metric associated with the plurality of flow feature vectors using an attention-based transformer of an artificial intelligence (AI) engine and determining a flow feature associated with the point based on the attention metric.

In an eighteenth aspect, in combination with the seventeenth aspect, the plurality of flow feature vectors include a first flow feature vector associated with a first object of the scene and further include a second flow feature vector associated with a second object of the scene different than the first object.

In a nineteenth aspect, in combination with one or more of the seventeenth aspect through the eighteenth aspect, the attention metric is based at least in part on cross-attention between the first flow feature vector and the second flow feature vector.

In a twentieth aspect, in combination with one or more of the seventeenth aspect through the nineteenth aspect, the method further includes initiating one or more operations associated with a vehicle based on the flow feature.

The various illustrative logics, logical blocks, modules, circuits, and processes described herein may be implemented as electronic hardware, computer software, or combinations of both. One or more features herein may be described generally, in terms of functionality, and illustrated in the various illustrative components, blocks, modules, circuits, and processes described above. Whether such functionality is implemented in hardware or software may depend upon the particular application and system design.

A hardware and data processing apparatus used to implement the various illustrative logics, logical blocks, modules, and circuits described herein may be implemented or performed with a single-chip processor or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may include, for example, a microprocessor, or any controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. A storage medium may be any available medium that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. An apparatus comprising:
a processing system including one or more processors and one or more memories coupled to the one or more processors, the processing system configured to:
receive a first point cloud representing a scene at a first time, wherein the first point cloud includes a point associated with a location within the first point cloud;
receive a second point cloud representing at least a portion of the scene at a second time after the first time;
determine one or more first neighbor points within the second point cloud that are within a first radius of the location;
determine one or more second neighbor points within the second point cloud that are within a second radius of the location, the second radius different than the first radius;
determine a multi-resolution flow embedding for the first point based on the one or more first neighbor points and the one or more second neighbor points; and
generate a scene flow model associated with the scene based on the multi-resolution flow embedding.

2. The apparatus of claim 1, wherein the processing system is further configured to:
determine a first motion encoding value based on the point and the one or more first neighbor points; and
determine a second motion encoding value based on the point and the one or more second neighbor points.

3. The apparatus of claim 2, wherein the processing system further includes an artificial intelligence (AI) engine configured to determine the first motion encoding value and the second motion encoding value based on a learnable function.

4. The apparatus of claim 2, wherein the processing system is further configured to sum the first motion encoding value and the second motion encoding value to determine the multi-resolution flow embedding.

5. The apparatus of claim 1, wherein the second radius is greater than the first radius, and wherein the one or more second neighbor points include at least one point not included in the one or more first neighbor points.

6. The apparatus of claim 1, wherein the processing system is further configured to initiate one or more operations associated with a vehicle based on the scene flow model.

7. A method of operation of a device, the method comprising:
receiving a first point cloud representing a scene at a first time, wherein the first point cloud includes a point associated with a location within the first point cloud;
receiving a second point cloud representing at least a portion of the scene at a second time after the first time;
determining one or more first neighbor points within the second point cloud that are within a first radius of the location;
determining one or more second neighbor points within the second point cloud that are within a second radius of the location, the second radius different than the first radius;
determining a multi-resolution flow embedding for the first point based on the one or more first neighbor points and the one or more second neighbor points; and
generating a scene flow model associated with the scene based on the multi-resolution flow embedding.

8. The method of claim 7, further comprising:
determining a first motion encoding value based on the point and the one or more first neighbor points; and
determining a second motion encoding value based on the point and the one or more second neighbor points.

9. The method of claim 8, wherein the first motion encoding value and the second motion encoding value are determined based on a learnable function of an artificial intelligence (AI) engine.

10. The method of claim 8, further comprising summing the first motion encoding value and the second motion encoding value to determine the multi-resolution flow embedding.

11. The method of claim 7, wherein the second radius is greater than the first radius, and wherein the one or more second neighbor points include at least one point not included in the one or more first neighbor points.

12. The method of claim 7, further comprising initiating one or more operations associated with a vehicle based on the scene flow model.

13. An apparatus comprising:
a processing system including one or more processors and one or more memories coupled to the one or more processors, the processing system configured to:
receive a point cloud representing a scene, wherein the point cloud includes a point associated with a location within the point cloud;
identify a plurality of neighbor points that are within a particular radius of the location within the point cloud;
determine a plurality of flow feature vectors respectively associated with the plurality of neighbor points;
determine an attention metric associated with the plurality of flow feature vectors using an attention-based transformer of an artificial intelligence (AI) engine; and
determine a flow feature associated with the point based on the attention metric.

14. The apparatus of claim 13, wherein the plurality of flow feature vectors include a first flow feature vector associated with a first object of the scene and further include a second flow feature vector associated with a second object of the scene different than the first object.

15. The apparatus of claim 14, wherein the attention metric is based at least in part on cross-attention between the first flow feature vector and the second flow feature vector.

16. The apparatus of claim 13, wherein the processing system is further configured to initiate one or more operations associated with a vehicle based on the flow feature.

17. A method of operation of a device, the method comprising:
receiving a point cloud representing a scene, wherein the point cloud includes a point associated with a location within the point cloud;
identifying a plurality of neighbor points that are within a particular radius of the location within the point cloud;
determining a plurality of flow feature vectors respectively associated with the plurality of neighbor points;
determining an attention metric associated with the plurality of flow feature vectors using an attention-based transformer of an artificial intelligence (AI) engine; and
determining a flow feature associated with the point based on the attention metric.

18. The method of claim 17, wherein the plurality of flow feature vectors include a first flow feature vector associated with a first object of the scene and further include a second flow feature vector associated with a second object of the scene different than the first object.

19. The method of claim 18, wherein the attention metric is based at least in part on cross-attention between the first flow feature vector and the second flow feature vector.

20. The method of claim 17, further comprising initiating one or more operations associated with a vehicle based on the flow feature.
